(19) United States
(12) Patent Application Publication
(10) Pub. No.: US 2014/0279085 A1
(43) Pub. Date: Sep. 18, 2014

(54) MENU SHARING SYSTEMS AND METHODS FOR TELEDINING

(71) Applicant: Mirza M. AHMAD, Great Falls, VA (US)

(72) Inventor: Mirza M. AHMAD, Great Falls, VA (US)

(21) Appl. No.: 13/839,229

(22) Filed: Mar. 15, 2013

(51) Int. Cl. G06Q 30/06; G06Q 50/12

(52) U.S. Cl. CPC G06Q 30/0641; G06Q 50/12
USPC 705/15

(57) ABSTRACT

A teledining system is configured to display shared menu information between geographically remote teledining session participants. The teledining system is configured to enable viewing of participant bills by any one or more of the session participants, and payment of bills by a session participant for a geographically remote participant(s).

### FIELD OF DISCLOSURE

The disclosure relates to teledining and restaurant networking. In particular, the disclosure relates to systems and methods for creating a virtual single, common, or joined restaurant by networking two or more restaurants at separate geographical locations.

### BACKGROUND

Systems and methods for teleconferencing and video conferencing are known. Various readily available systems enable real-time one-way or two-way video and/or audio communication. Teleconferencing systems have been enhanced by telecommunications advancements such as voice-over-internet protocol, and advancements in component and device design, including the introduction of relatively inexpensive and highly functional tablet PC's.

Teleconferencing enables at least two persons in geographically remote locations to communicate with one another, and has been found to be exceedingly useful for business meetings, and communicating over large distances with friends and/or family members. Because it is desirable to conduct, for example, a business meeting while dining, some restaurant and hotel chains accommodate teleconferencing for local guests meeting with remotely located guests at another restaurant or hotel in the chain using related art systems that provide video and audio communication. Many teleconferencing systems and components that are now known or later developed may be implemented for related teleconferencing while dining, or teledining.

For example, U.S. Pat. No. 6,844,893 to Miller et al. discloses a system and a method that combine restaurant services with video-conferencing and multi-media access for diners. Miller discloses a system that uses a number of booths in a number of restaurants whereby each booth can video-conference with each other booth, particularly in different time zones. The local area network of each restaurant is linked to the local area network of each other restaurant forming a corporate intranet for secure exchange of video, audio, and data, including a Point-of-Sale (POS) system data. Food, beverage, and retail operations in each restaurant are controlled by the POS system. Thus, Miller discloses co-locating teleconferencing systems and dining service systems, while also disclosing methods for enhancing dining service specifically by way of the POS system.

Other systems for enhancing dining service are known. For example, U.S. Pat. No. 7,454,370 to Baril et al. discloses an ordering system for a restaurant. The system includes an electronic menu having a series of input devices corresponding to various menu items aligned with the input devices, and a wireless transmitter to send selected menu items to a local receiving device in the restaurant for processing. The system further includes an alpha-numeric keyboard, a non-cash payment device, and a printer for printing receipts. Baril discloses using multiple menus at a same table, and providing the option to pay for the items purchased from other menus at the same table.

Systems and methods for enhancing dining services are generally directed to activities local activities at a particular restaurant. For example, U.S. Patent Application Publication Nos. 2003/0078793 to Toth discloses an enhanced customer-centric restaurant system. The system provides an automated restaurant experience for customers. An access unit that customers use to order food and drinks while seated at the table also allows a table's bill to be paid. The billing screen includes a series of payment buttons which allow the table to decide to pay individually, as couples, as a group, or any similar variations.

### SUMMARY

Teledining systems and methods are provided to enhance dining experiences by unifying two or more geographically separate restaurants for a period of time. Systems and methods enhance dining experiences by uniting users that are located at separate restaurants for a period of time through a common teledining experience that joins the various restaurants at which the separated users are located. Systems and methods include menu sharing and/or payment sharing. Systems and methods may be configured to include teleconferencing by way of, for example, video and/or audio teleconferencing.

In an embodiment, methods may include a method for joining geographically separate users, the users being located in at least two geographically separate dining establishments, including displaying menu information using an electronic display device to a host at a first dining establishment, wherein the menu information includes at least one item or service included on the menu of a second dining establishment. Methods may include displaying at least one item or service included on the menu of the first dining establishment to the guest at the second dining establishment. Methods may include displaying prices for the menu item or service to the host and optionally the guest. Methods may include receiving data and instructions for initiating a teledining session, wherein the guest may join the session; displaying the teledining session status on the display device to the host; and displaying a status of guest attendance on the display to the host.

In an embodiment, methods may include receiving a request from a guest to join the initiated teledining session, the initiated teledining session being pending or in progress. Methods may include receiving data from the guest that is compared with saved data for the initiated session to determine whether the data received from the guest is authenticated; and enabling the guest to join the teledining session depending on whether the received data is authenticated. Methods may include receiving a meal order from a guest; and communicating the meal order to the host at the first restaurant. Methods may include prompting the host to place order based on the communicated meal order. Methods may include receiving the host's approval of the meal order.

In an embodiment, methods may include communicating billing information to the host after the receiving the host's approval; receiving payment information and/or instructions from the host to pay for items billed by the second dining establishment; and causing payment, including at least one of the price of ordered item(s) and/or service(s), gratuities, and taxes, to be made from the host to the second dining establishment. Methods may include establishing at least one of an audio or video connection between a host a first dining establishment and a guest at a second dining establishment for teleconferencing during the teledining session. Methods may include prompting the host to view teledining session status information on the device using an audible alarm or visual cue. In an embodiment, the received data may include restaurant location data for comparing with saved restaurant location data optionally selected by a host.

In an embodiment, methods may include displaying teledining session information to the host and/or user. The teledining session information may include information selected from the group comprising: a number of guest(s) at a dining establishment, a number of guest(s) present, an identity of guest(s), an identify of guest(s) present, and an identify of connected dining establishment(s). Methods may include updating the electronic display device with computer-readable instructions. The instructions may include instructions for display a graphical user interface.

In an embodiment of systems, a teledining system may include an electronic display device configured for displaying menu information to a host at a first restaurant, the menu information relating to menu items and/or services at a second restaurant; and a central server for communicating menu information from the second restaurant to the electronic display device at the first restaurant.

In an embodiment of apparatus, a non-transitory computer-readable medium storing instructions for controlling a teledining system may include causing an electronic display device located at a first restaurant to display menu information related to a second restaurant. Instructions may include causing the electronic display device to display a prompt to join or create a teledining session; causing the electronic display device to communicate a user selection to join or create a teledining session to a central server; and causing the electronic display device to receive menu information related to the second restaurant from the central server.

Exemplary embodiments are described herein. It is envisioned, however, that any system that incorporates features of systems described herein are encompassed by the scope and spirit of the exemplary embodiments.

### BRIEF DESCRIPTION OF THE DRAWINGS

FIG. 1 shows a diagrammatical view of a teledining system in accordance with an exemplary embodiment;

FIG. 2 shows methods for accommodating shared-menu teledining hosting in accordance with an embodiment;

FIG. 3 shows methods for hosting teledining session in accordance with an embodiment.

### DETAILED DESCRIPTION

Exemplary embodiments are intended to cover all alternatives, modifications, and equivalents as may be included within the spirit and scope of the apparatus and systems as described herein.

Reference is made to the drawings to accommodate understanding of systems for teledining in accordance with systems and methods of embodiments. In the drawings, like reference numerals are used throughout to designate similar or identical elements. The drawings depict various embodiments of illustrative systems and methods for teledining.

Systems and methods of embodiments accommodate teledining and menu sharing to unify two or more restaurants for a period of time, uniting remotely located guest in one dining experience, and joining two or more restaurants for a common or shared dining experience for users. In particular, systems and methods unify two or more dining establishment such as restaurants, pubs, coffee shops, etc., into a single virtual restaurant for a period of time. The restaurants, pubs, coffee shops, etc., may be co-owned or independently owned and operated. Systems and methods include providing shared menus to the guest(s) and/or host(s). Participants such as host(s) and guests located at the two or more separate restaurants may access multiple menus including a local menu at which the host or guest as located, and a menu of a remote restaurant at which an attendee host or guest is located. The menu (or menus at the table) shows items for sale, such as food, beverages, retail goods, teledining session time, etc. that are available for sale at one or more of the dining establishment(s) participating in the teledining session. For example, a host may choose or suggest a particular dinner for a specific guest located at a geographically remote, but virtually present restaurant during the teledining session.

Menus may be presented to guests to a teledining session in paper form in some embodiments, which an electronic. In other embodiments, menus may be presented to guest(s) and host(s) using an electronic display device. In particular, systems may include an electronic display device such as a table computing device, mobile smart phone device, stationary or mobile personal computer and display systems, or any combination of the myriad of components now available or later developed for enabling network communication, processing of user inputs by way of an input device such as a keyboard or touch screen display, and display to a user of data, which data may include locally generated data, and data received at the device from a remote device connected to by one or more wired and/or wireless local area and/or wide area networks.

The electronic display device may be configured to display a graphical user interface with a look and feel that is unique to a particular restaurant in which it is used. The electronic display device may be connected to a local area network at the restaurant on which a local server is also located for receiving data from and providing data to the electronic device. Alternatively, or additionally, the electronic device may be configured to communicate with a remote server by way of at least one wired and/or wireless wide area network for sending and receiving data such as menu data, teledining session data, software updates, etc.

For example, the data communicated between components of the network include menu information of connected restaurants or other dining establishments, teledining session information such as attendee identification and contact information, session or room locations (restaurant access locations at which reservations for dining are made), dates and times, pricing, billing, payment information and instructions, including data necessary for effecting online transactions for payment from one or more attendees to one or more restaurants using systems now available and later developed for accommodating online electronic transactions.

Systems may include a central server. The central server may be located at any one restaurant among a plurality of restaurants having local electronic menu display devices, or located at a separate geographically remote location and connected to the teledining network. The central server may hold management software and teledining session records. The central server may include a database of restaurants, associated restaurant ID's, address, phone, email, directions, and menu information, which may be updated as desired, or at periodic intervals. The teledining session records may include payment information, records of all billings and payments, records of all room or session numbers or similar identifier, host names, etc.

In systems of some embodiments, teledining systems may be connected to or may incorporate a component of now available or later developed third-party billing systems capable of tabulating purchases, generating invoices, distributing payments, and/or accommodating online transactions. Systems and methods of embodiments may accommodate payment sharing. In particular, systems and methods of embodiments may be configured to accommodate payment by at least one participant of a teledining session of at least one other geographically remote participant's bill. Systems may be configured to enable payment in any currency, automatic distribution of payment and tips, automatic payment of local service charges, taxes, and other items or services that are typical of, e.g., lunch or dinner meetings that are held in a single geographical location, in the same room, or at the same table. Systems and methods enable intuitive teledining management with menu sharing and/or payment sharing, and a user experience that provides a feel of meeting with guests in a single restaurant, despite the physical distance between attendee guest(s) and/or host(s) at separate dining locations.

Each dining location may have at least one tablet device, for example, which is loaded with software configured for providing a graphical user interface that is unique to the dining location at which the tablet device resides. A user may enter a restaurant and access the device. The device may be configured to display a prompt and interface for inputting an instruction for joining a room or session as a guest, or creating a room as a host for other guests to join. If the user logs in as a host, the device may be configured to prompt the user to enter a room name, host name, and password, for example, for a new session. The session information may be provided to invited guests, for example, for logging into the teledining system upon arrival at a dining establishment that is equipped for using teledining systems in accordance with embodiments.

After initiating a room or session, the device may be configured to enable access to the room or session by displaying an interface presenting menu data. For example, the menu of the local restaurant may be displayed by the device. The device may be configured to enable the user to cause the device to display menu data corresponding to restaurants at which guest(s) to the teledining session are located. The menu data may be obtained from a local server or a central server as described above. The device may also be configured to enable users to cause the device to view billing data, guest and attendee data, session data including attendance data, time data including time remaining in current session, interfaces for initiating teleconferencing in suitably configured systems that enable teleconferencing by way of video and/or audio, and other options that are useful for menu sharing to unify two or more restaurants for a period of time.

The menu may show menu items available at each respect location, and may display such items to both users. The menu of each restaurant may be viewable as separate and distinct menus that are separately selectable by the guest(s) and/or host, or as one combined menu, depending on the configuration of the graphical interface(s) and the device configuration as operated according to corresponding computer readable instructions. The menu interface may be configured, for example, to enable a physical rather than virtual look and feel, including page-turn appearance, photographs of entrees, pricing, current chef, manager, etc. The menu data for each device at each restaurant may be updated from a local server at each restaurant and/or from a central server.

The host may select an audio and/or video-teledining option if the systems used by both the host and remotely connected guest are suitably equipped with video teleconferencing equipment now known or later developed. For example, now known or later developed voice-over-internet protocol systems and internet video conferencing systems that are readily suitable for use on personal mobile devices may be used in combination with menu sharing in teledining systems and methods of embodiments. Video and/or audio teleconferencing may be selectable as a purchasable add-on to a teledining session, the option being presented to the guest(s) and/or host at the display device.

After guests log into a teledining session, orders may be submitted. Systems may be configured to enable display of guest orders to the host. Systems may be configured wherein the host may be prompted to approve menu orders, after which the orders at each respective restaurant may be submitted for preparation. When a meal is complete, and a teledining session is about to end, the host may pay for all session participants, or selected participants. Systems may be configured for payment to be distributed automatically to select restaurants, for example, including payment for items, services, tips, taxes, etc.

FIG. 1 shows a teledining system in accordance with an embodiment. Individual system components are known, although later developed system components may implemented for forming systems while in accordance with embodiments. FIG. 1 shows a teledining system network 100 having a plurality of teledining display device systems 102, 104, 105, and 107. Each device system 102, 104, 105, and 107 may include one or more display devices located at respective restaurants. For example, device system 102 may include a device configured to display menu information pertaining to the restaurant at which system 102 is located, and menu information pertaining to one or more of the respective restaurant locations at which display device systems 102, 104, 105, and 107 are located. Each device system may include one or more tablet computing device that is configured to display menu information, for example, each device system being located at a geographically separate dining location.

If a host accesses a display device system 102 to connect with a guest at system 104, the session may be enabled by displaying menu information for the restaurant at which the guest is located, and menu information for the local restaurant at which the host is located. The guest may be provided with a paper menu or an electronic menu. Systems may optionally be configured to enable guests to see remote guests and host menu information. Systems may be configured so that any two or more of systems 102, 104, 105, and 107 are enabled for video and/or audio communication using, for example, appropriately configured teleconferencing components.

The display device systems 102, 104, 105, and 107 may be connected to and/or by a wide area network 110, for example, or other wired and/or wireless networks. The network components may be operably connected using wired or wireless connections, or a combination thereof. The teledining system network 100 may include a teledining restaurant database 118, a restaurant menu database 120, and a teledining session and payment database 125, an online billing/payment system software module, for example, and other databases as desired such as a database of videoconferencing channels, etc.

The display devices may be configured to communicate with a central teledining server 130. For example, a host teledining display device 107 may communicate with the central teledining server 130 to initiate a teledining session with one or more of the remote device systems 102, 104, and 105. The central teledining server 130 may query the restaurant database 118 to confirm restaurant registration with a teledining system before attempting connection. The central teledining server 130 may also provide menu information for one or more connected teledining systems to a requesting host teledining system, the menu information being stored in the menu database 120, which communicates with the sever 130.

Alternatively, in some systems, menu information may be communicated directly between restaurants for menu sharing during a teledining session. Also, payment information may be communicated directly between participating restaurants in suitably configured systems. In some systems, menu information may be stored at a server located at one or more of each respective device system for each respective dining location. A device may be updated with new configuration instructions, including interface data, and menu information from a local server and/or a central server.

The central teledining server 130 shown in FIG. 1 may retrieve teledining session information such as teledining session party identification, scheduling information, etc. stored on the session and payment database 125, and provide the information to a requesting host system. A host teledining system may receive and view a bill a related to a party teledining system from the central teledining server 130, and may effect payment of a bill related to the party teledining system by way of the teledining server 130.

FIG. 2 shows methods for teledining in accordance with a preferred embodiment for menu sharing to join or unify at least two dining locations. In particular, FIG. 2 shows a teledining process 200. Process 200 includes providing at S2001 an electronic menu including a graphical user interface(s) configured for displaying and providing, e.g., local menu, number of remote attendee guests, number of local attendee guests, number and/or identity of connected restaurants, names of attendees and respective dining locations, options for initiating a teledining session, menu of remote dining location(s), meal and/or beverage orders, running total bill for remote and/or local guest(s). Teledining may include shared payment, and may optionally include video and/or video teleconferencing system components and methods.

Methods may include at S2003 receiving input from host for initiating teledining session with guest(s) in remote dining location, and corresponding session data including, e.g., names, contact information, session time, location(s). Input may be received by way of any now available or later developed input systems and methods such as keyboard, touch screen, etc. Methods may include at S2005 providing initiated teledining session at least by displaying menu of guest(s) on host graphical user interface based on the received session data. Local and remote menu information may be displayed to the guest on the device. For example, the user may be presented with a navigable user interface that enables selection of icons representing local and guest menus.

Methods may include at S2009 receiving meal/beverage order, re-order, or adjusted order from host, and/or meal/beverage order, re-order, or adjusted order from guest attendees. At S2011, methods may include displaying meal/beverage order(s) of guest to the host. Methods may include at S2015 receiving host order approval, order veto, and/or order suggestion. The host may, for example, approve or confirm host and/or guest, after which the various restaurant(s) for which orders were submitted may proceed to satisfy the order(s) by, for example, preparing food and/or beverages. For example, the device may be configured to prompt the host to cause the system to place an order with one or more of the connected restaurants. In some embodiments, the user may be provided with an option to veto or override a particular order.

Orders may be placed at a same time, or at separate times. Orders may be adjusted. Activities and status of guests, and teledining session status and information may be displayed to users during a teledining session at respective display devices. After meals are served, and the orders are complete, methods may include at S2021 displaying a bill to the host. The bill may include charges incurred by the host, and may include charges incurred by the guests.

Methods may include enabling the host to pay for one or more guest(s)' charges as desired. Systems may be configured to enable electronic payment of food, beverage, service charges, including teleconferencing charges, etc. In some embodiments, methods may include displaying billing information to one or more guests. Methods may include receiving at S2025 instructions from the host to pay tip and/or bill for guest and/or host. The session may end at a desired time. For example, systems may be configured to prompt the host to end the teledining session, and guests may log on/out at any time as desired. Methods may include displaying to a host or guest options for ending and/or leaving, joining, creating presently or in the future, a teledining session.

FIG. 3 shows an embodiment of methods for guest participation in a teledining session in accordance with an embodiment. In teledining method 300, a guest or co-host accesses a dining establishment that is equipped and configured with teledining display system in accordance with an embodiment. Optionally, in alternative embodiments, guests may have paper menus, and only the host may see various menus of connected guests. Methods as shown in FIG. 3 may be implemented with teledining systems such as those shown in FIG. 1. Systems may be operated in accordance with methods to enable shared menu teledining, optionally including payment management for paying on behalf of connected guest(s) using electronic or online payment/transaction systems now known and later developed, e.g., third-party online transaction platforms, and optionally combined with teleconferencing systems and methods.

For example, methods may begin with a guest or co-host accessing a restaurant or other dining establishment, and being provided with a paper or electronic menu at S3035. The guest may access the teledining system. If a teledining room or session has already been initiated, the teledining system may enable access to the teledining session at S3039. A guest may join an initiated or scheduled teledining session by inputting data into the teledining system at a suitable connected user interface, the data including, for example: attendee name, room and/or host name, and/or room code, and/or password. If such data is authenticated at S3041, the system may enable the guest to join the initiated teledining session.

At S3045, the guest may participate in the teledining session wherein a common menu is shared among geographically remote attendees, optionally along with single billing, pricing, and payment data as desired. For example, a guest may place a meal order at S3049. Before the teledining session ends, a geographically remote host, having viewed the shared menu, pricing, and final bill, may pay the guest's bill, including tax and tip, with currency conversion being automatic, or handled by known methods.

At S3051, methods may include receiving host confirmation of meal/beverage order, and the meal(s) and/or beverage order(s) may be prepared by each restaurant as appropriate. As a meal ends, or at any time during, before, or after a teledining session, methods may include at S3055 communicating billing information to guests and/or the host. In particular, systems may be configured to display a running bill total during the teledining session to the host. The host may approve payment for selected guests, and cause payment to be made to respective restaurant for items, services, gratuities, etc. Guests may communicate with other guests and with the host. For example, guests may contact the host to indicate that a new local guest has arrived and that an order needs to be adjusted. The host may be prompted by an audio and/or visual cue to receive the guest communication.

Embodiments as disclosed herein may also include computer-readable media for carrying or having computer-executable instructions or data structures stored thereon. Such computer-readable media can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures. When information is transferred or provided over a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable media.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, objects, components, and data structures, and the like that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described therein.

It will be appreciated that the above-disclosed and other features and functions, or alternatives thereof, may be desirably combined into many other different systems or applications. Also, various presently unforeseen or unanticipated alternatives, modifications, variations or improvements therein may be subsequently made by those skilled in the art.

What is claimed is:

1. A method for joining geographically separate users, the users being located in at least two geographically separate dining establishments, comprising:
displaying menu information using an electronic display device to a host at a first dining establishment, wherein the menu information includes at least one item or service included on the menu of a second dining establishment.

2. The method of claim 1, comprising:
displaying at least one item or service included on the menu of the first dining establishment to the guest at the second dining establishment.

3. The method of claim 1, the displaying further comprising:
displaying prices for the menu item or service to the host and optionally the guest.

4. The method of claim 3, comprising:
receiving data and instructions for initiating a teledining session, wherein the guest may join the session;
displaying the teledining session status on the display device to the host; and
displaying a status of guest attendance on the display to the host.

5. The method of claim 4, comprising:
receiving a request from a guest to join the initiated teledining session, the initiated teledining session being pending or in progress.

6. The method of claim 5, the receiving further comprising:
receiving data from the guest that is compared with saved data for the initiated session to determine whether the data received from the guest is authenticated; and
enabling the guest to join the teledining session depending on whether the received data is authenticated.

7. The method of claim 6, comprising:
receiving a meal order from a guest; and
communicating the meal order to the host at the first restaurant.

8. The method of claim 7, comprising:
prompting the host to place order based on the communicated meal order.

9. The method of claim 8, comprising:
receiving the host's approval of the meal order.

10. The method of claim 9, comprising:
communicating billing information to the host after the receiving the host's approval;
receiving payment information and/or instructions from the host to pay for items billed by the second dining establishment; and
causing payment, including at least one of the price of ordered item(s) and/or service(s), gratuities, and taxes, to be made from the host to the second dining establishment.

11. The method of claim 1, comprising:
establishing at least one of an audio or video connection between a host a first dining establishment and a guest at a second dining establishment for teleconferencing during the teledining session.

12. The method of claim 7, comprising:
prompting the host to view teledining session status information on the device using an audible alarm or visual cue.

13. The method of claim 6, wherein the received data includes restaurant location data for comparing with saved restaurant location data optionally selected by a host.

14. The method of claim 1, comprising:
displaying teledining session information to the host and/or user.

15. The method of claim 14, wherein the teledining session information comprises information selected from the group comprising: a number of guest(s) at a dining establishment, a number of guest(s) present, an identity of guest(s), an identify of guest(s) present, and an identify of connected dining establishment(s).

16. The method of claim 1, comprising:
updating the electronic display device with computer-readable instructions.

17. The method of claim 1, wherein the instructions comprise instructions for display a graphical user interface.

18. A teledining system, comprising:
an electronic display device configured for displaying menu information to a host at a first restaurant, the menu information relating to menu items and/or services at a second restaurant; and
a central server for communicating menu information from the second restaurant to the electronic display device at the first restaurant.

19. A non-transitory computer-readable medium storing instructions for controlling an a teledining system, comprising:
causing an electronic display device located at a first restaurant to display menu information related to a second restaurant.

20. The non-transitory computer-readable medium of claim 19, comprising:
causing the electronic display device to display a prompt to join or create a teledining session;
causing the electronic display device to communicate a user selection to join or create a teledining session to a central server; and
causing the electronic display device to receive menu information related to the second restaurant from the central server.
